(19) United States
(12) Patent Application Publication
(10) Pub. No.: US 2005/0284966 A1
(43) Pub. Date: Dec. 29, 2005

(54) Emitter

(76) Inventor: Michael DeFrank, Temecula, CA (US)

Correspondence Address: IPLM GROUP, P.A., POST OFFICE BOX 18455, MINNEAPOLIS, MN, 55418, US

(21) Appl. No.: 10/875,074

(22) Filed: Jun. 23, 2004

(51) Int. Cl. B05B 15/00

(52) U.S. Cl. 239/542

(57) ABSTRACT

An emitter and hose assembly (10) includes a hose (20) and an emitter (30). The emitter is assembled with a light transmissive cover (40) to an absorptive cover receiving area (77) on a body section (60) by laser welding. The flow path through the emitter (30) is defined by the emitter itself and is not dependent on the inner surface (20a) of the hose (20).

### BACKGROUND OF THE INVENTION

1. Field of the Invention

This invention relates generally to a drip irrigation emitter and more particularly to an emitter that utilizes laser welding to bond two parts together to form an internal pathway for use in controlling the volume of water passing through the emitter.

2. Description of the Prior Art

Two different types of drip irrigation emitters are known in the art. All drip irrigation emitters are associated in some way with a conduit line through which a pressurized fluid may flow. The fluid can be anything, but is typically water for growing plants, either by itself or with dissolved additives, such as fertilizers or nutrients. Drip irrigation emitters may be attached along the outside of the conduit line, or they may be inserted into the inside of the conduit line that allows fluid to reach the outside. In every drip irrigation emitter, there is some means for allowing the fluid inside of the line to reach the outside at a specified rate of flow.

For discrete emitters that are inserted into the conduit line, there are two general types. The first is a cylindrical emitter, such as that shown in U.S. Pat. No. 5,628,462. Another style of emitter is a substantially flat emitter that is heat welded at axially spaced apart locations on the inner surface of the conduit. Such an emitter is shown in U.S. Pat. No. 4,307,841.

Another type of drip irrigation is accomplished by a system that employs a hose having a continuous emitter such as AQUA-TRAXX® hose of The Toro Company. Such hose includes the use of a continuous non-elastic strip which, in conjunction with the hose, forms a plurality of emitters.

Assembly of a discrete emitter, especially the discrete emitters that utilize a pressure compensating feature, may require strict quality control and performance inspections in order to assure that the emitter is acceptable. Further, the discrete emitters often utilize the hose wall to form a portion of the flow path. However, there are some examples of discrete emitters, such as shown in U.S. Pat. No. 6,382,530 that do not use the hose wall. In addition, there is a pressure compensating emitter by Netafim, sold under the trademark Ram Heavywall Dripperline that does have a flow path not formed by the wall of the hose.

### SUMMARY OF THE INVENTION

In one embodiment, the invention is a drip irrigation emitter. The emitter is operatively connected in a bore of a conduit which carries a fluid. The conduit has an inner wall. The emitter includes a light transmissive cover having a cover inlet. A body section includes a body inlet in fluid communication with the cover inlet. The body has a body outlet. A pressure reducing passageway is in fluid communication with the body inlet and the body outlet. The first outlet chamber is in fluid communication with the body outlet. An absorptive cover receiving area is arranged and configured to receive the cover, wherein when laser welding is utilized to assemble the cover to the body, the body and cover are sealed together.

In another embodiment, the invention is a drip irrigation emitter. The emitter is operatively connected in a bore of a conduit which carries a fluid. The conduit has an inner wall. The emitter has a light transmissive cover having a cover outlet. A body section includes a body inlet in fluid communication with the cover outlet. The body section has a body outlet and a pressure reducing passageway is in fluid communication with the body inlet and the body outlet. A first outlet chamber is in fluid communication with the body outlet. An absorptive cover receiving area is arranged and configured to receive the cover. The absorptive cover receiving area is dark colored and contains carbon, wherein when laser welding is utilized to assemble the cover to the body, the body and the cover are sealed. A reservoir is formed in the body section. The reservoir is positioned between the body inlet and the body outlet. A resilient member is supported across the reservoir, wherein the reservoir has a first cavity and a second cavity. The pressure reducing passageway has a first end in fluid communication with the first cavity and a second end in fluid communication with the second cavity, wherein when pressure in the conduit increases, the resilient member deflects toward the body outlet, thereby compensating for pressure changes in the conduit. The cover is positioned over the pressure reducing pathway and reservoir, wherein a flow path for the fluid is defined by the emitter.

In another embodiment, the invention is a method of assembling a drip irrigation emitter. The emitter has a light transmissive cover and a body having an absorptive cover receiving area arranged and configured to receive the cover. The method includes clamping the cover to the cover receiving area under pressure. Laser radiation is passed through the light transmissive cover and the absorptive cover receiving area being heated, and melting an interface between the cover and the body, wherein the cover and body are joined.

### BRIEF DESCRIPTION OF THE DRAWINGS

FIG. 1 is an elevational view of an emitter of the present invention assembled in a conduit line, which is shown in cross section;

FIG. 2 is a perspective view of the emitter shown in FIG. 1;

FIG. 3 is an exploded perspective view of the emitter shown in FIG. 2;

FIG. 4 is a top plan view of the cover of the emitter shown in FIG. 2;

FIG. 5 is a top plan view of the body of the emitter shown in FIG. 3;

FIG. 6a is a cross sectional view of the emitter shown in FIG. 2, taken generally along the line 6-6, shown in a closed position;

FIG. 6b is a cross-sectional view of the emitter shown in FIG. 2, taken generally along the lines 6-6, shown in a midway position;

FIG. 6c is a cross-sectional view of the emitter shown in FIG. 2, taken generally along the lines 6-6, shown in a compensating position;

FIG. 7 is a bottom plan view of the emitter shown in FIG. 2;

FIG. 8 is a perspective view of the cover shown in FIG. 4, viewed generally from underneath; and

FIG. 9 is a bottom plan view of the cover shown in FIG. 4; and

FIG. 10 is a bottom perspective view of the body section shown in FIG. 3.

### DETAILED DESCRIPTION OF A PREFERRED EMBODIMENT

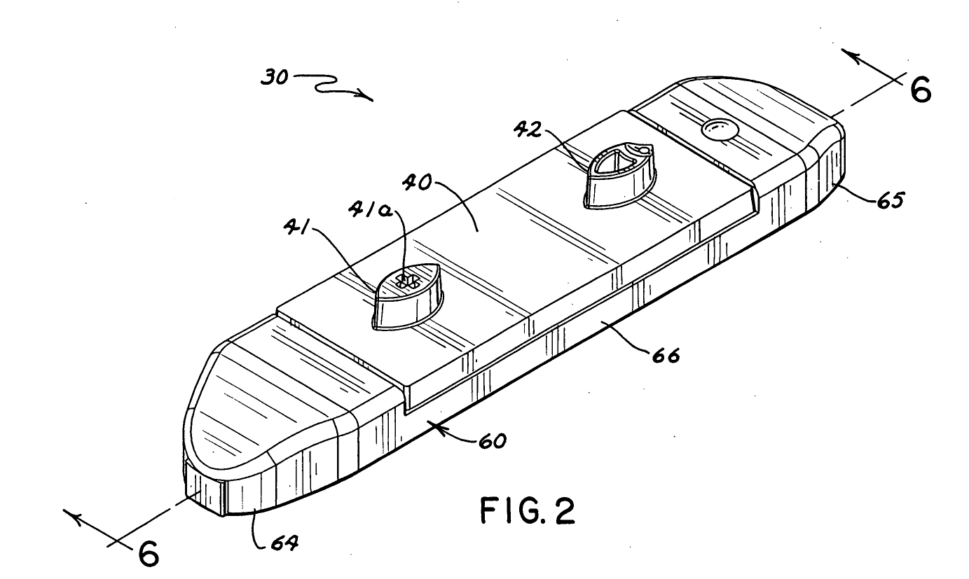

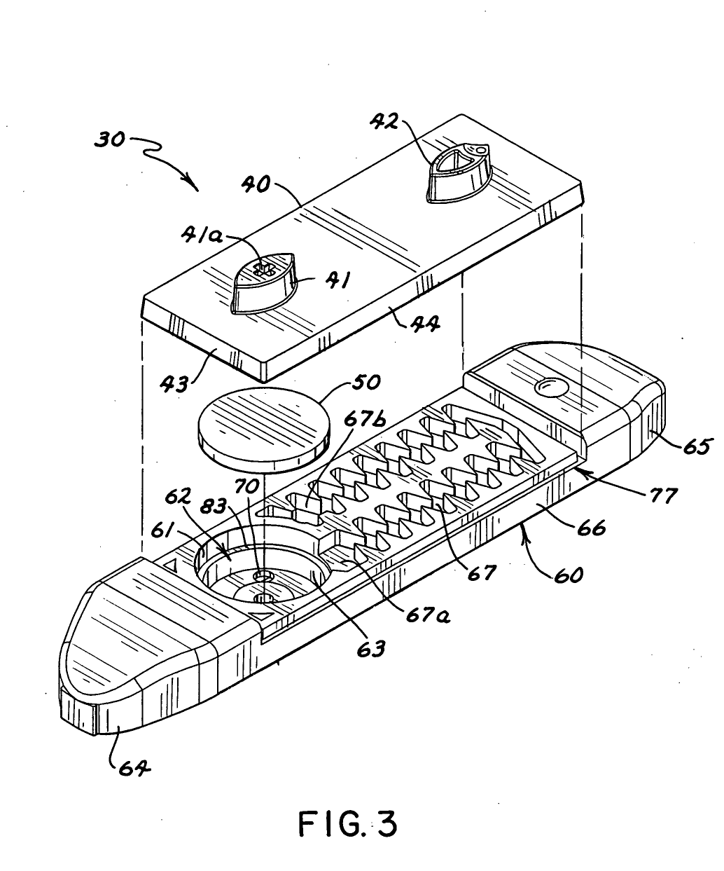

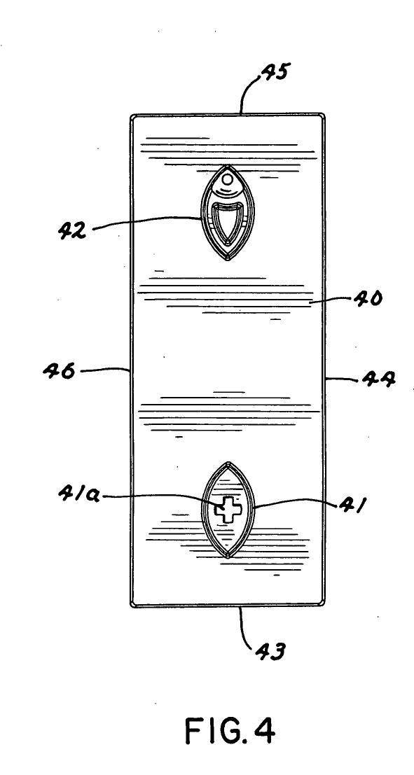

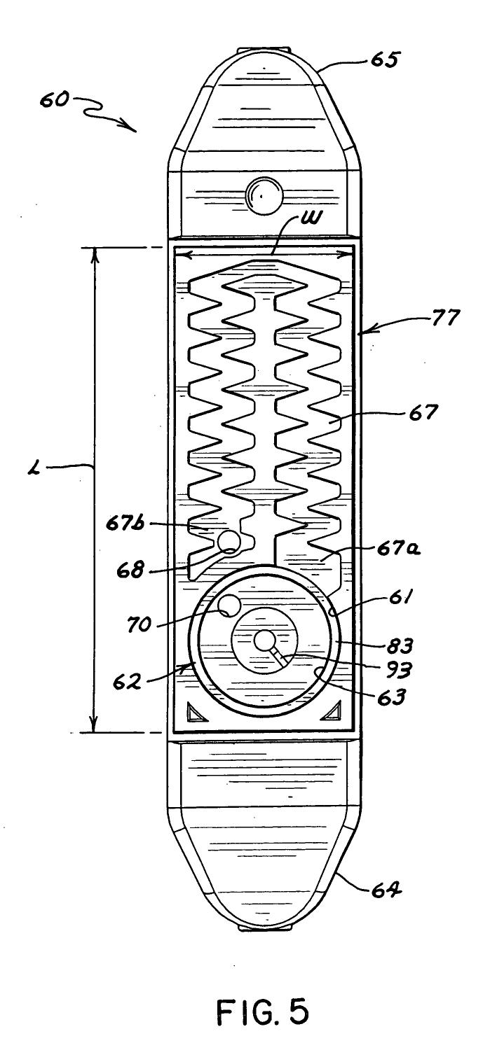

Referring to the drawings, wherein like numerals represent like parts throughout the several views, there is generally disclosed at 10 an emitter and hose assembly. The emitter and hose assembly 10 include a hose 20 having an inner surface 20a forming a bore 20b. The hose may be of any suitable length such as 500, 1,000 or more feet per roll. A plurality of emitters 30 are operatively connected to the inner surface 20a at suitably spaced intervals, as will be described more fully hereafter. The emitter 30 is shown assembled in FIG. 2 and unassembled in FIG. 3. The emitter 30 includes a cover 40, a flexible diaphragm or disc 50, and a body section generally designated 60. The cover 40 is made from a suitable plastic which provides enough optical clarity to allow laser light to pass through it. Preferably, the plastic is light transmissive in the 730-840 nanometer range. Such a cover 40 is referred to as being light transmissive. Having optical clarity also provides the advantages of increased and better quality and performance inspections. A suitable plastic is polyethylene. The cover 40 is rectangular in shape. The cover 40 is sized and configured to fit with a particular area of the body 60 as will be discussed more fully hereafter. Accordingly, the cover 40 could take on any suitable shape or size. In the embodiment shown in FIG. 4, the cover 40 has an inlet member 41 that has a bore 41 a extending therethrough. The top of the bore 41 a has a cross-shaped opening and is in fluid communication with a fluid that is being transmitted through the bore 20b of the hose 20. The fluid is typically water, but also may be other liquids or may be dissolved with additives such as fertilizer or nutrients. The other end of the bore 41a is in fluid communication with a first cavity 61 of a reservoir 62. The reservoir 62 also has a second cavity 63. The diaphragm 50 is sized and configured to fit inside of the reservoir 62 on the ledge 83. It can therefore be seen that the diaphragm 50 divides the reservoir 62 into the first cavity 61 and the second cavity 63. The cavities 61, 63 are separated from each other by the diaphragm 50. The diaphragm 50 is in the shape of a disc and is constructed from a suitable material such as silicon.

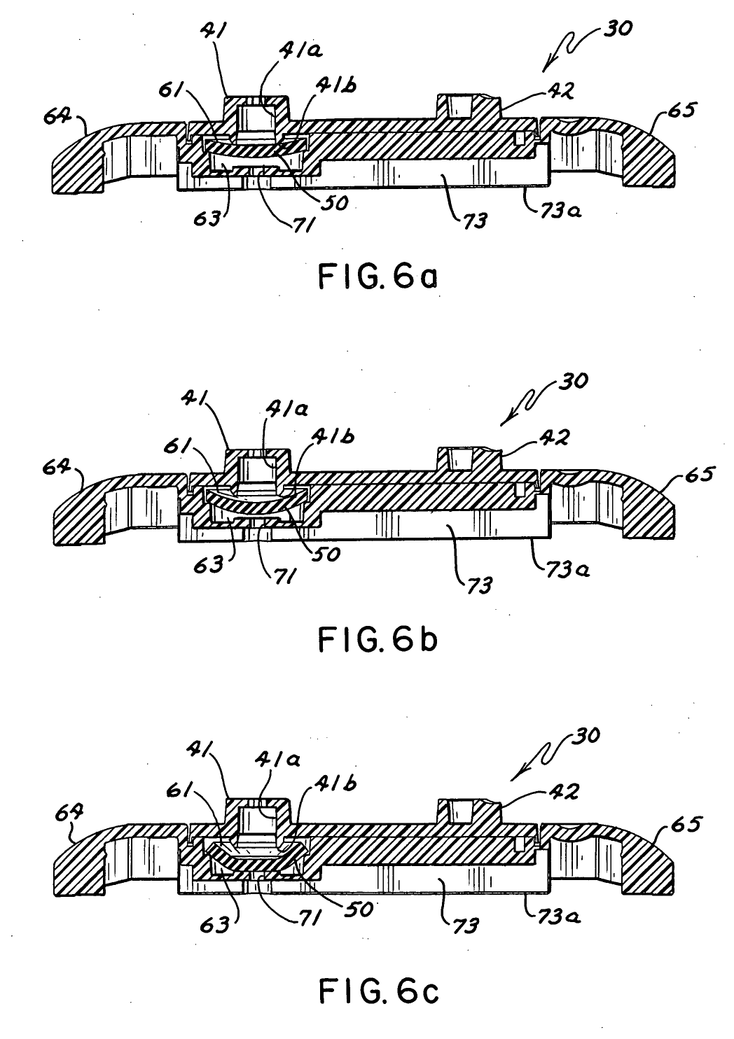

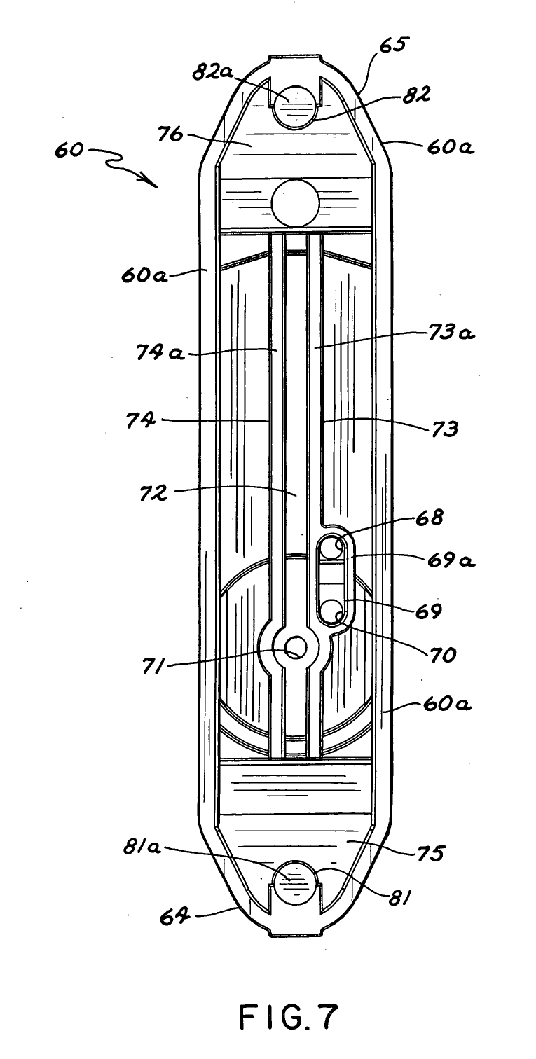

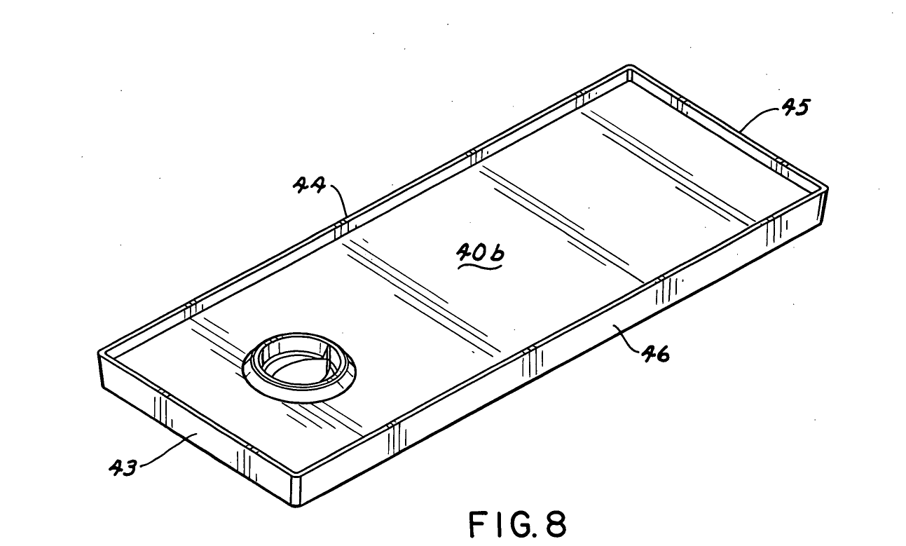

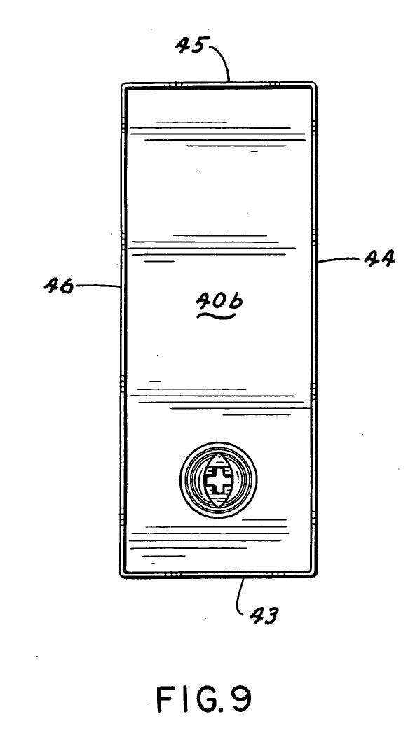

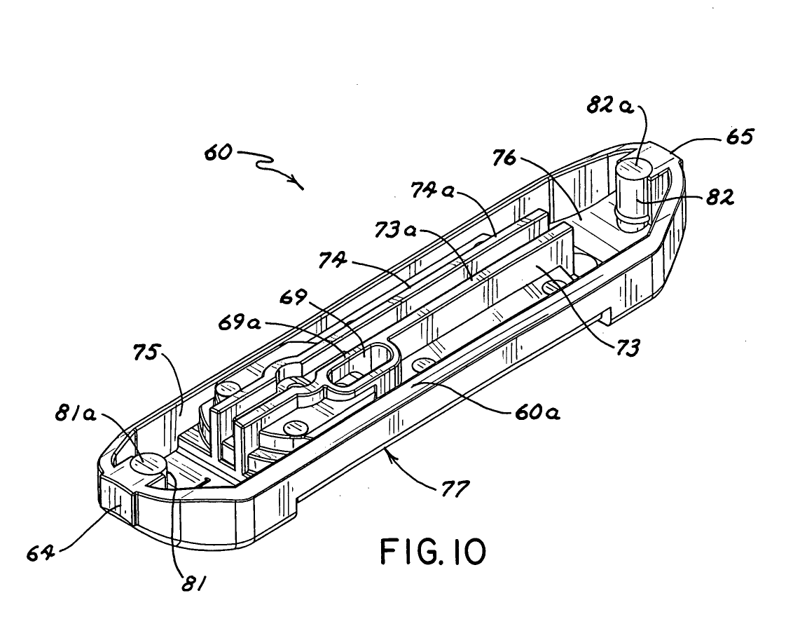

The cover 40 has a top surface 40a on which the inlet member 41 is positioned. The inlet member 41 has a circular member 41b that extends below the bottom surface 40b of the cover 40. As can be seen in FIG. 6a-6c, the bore 41a has a smaller first diameter at the inlet and increases to a second, larger diameter proximate the circular member 41b. In addition, there is a second protruding member 42 that extends above the top surface 40a. The function of the protruding member 42 is for use in guiding the emitter with automatic handling equipment while the emitter 30 is being inserted into the hose 20. Both the protruding member 42 and inlet member 41 have an aerodynamic shape to minimize turbulants of water flowing past the emitter 30 while in the hose 20. The cover 40 has four sides 43-46. When viewed from underneath, as shown in FIGS. 8 and 9, it can be seen that the sides 43-46 extend beyond the bottom surface 40b and thereby form a cover or lid that is secured to a cover receiving area on the body section 60, as will be described more fully hereafter.

The body section 60 is generally elongate and has a first end 64 and a second end 65. Although, as will be discussed hereafter, the emitter 30 is able to be assembled into the hose 20 in either direction, therefore the first end 64 or the second end 65 may be the leading end, depending upon which way the emitter 30 is secured in the hose 20. The central section 66, that is between the first end 64 and second end 65, includes the reservoir 62. The diaphragm 50, which is positioned on the ledge 83, prevents fluid from going directly from the first cavity 61 to the second cavity 63. Instead, when the fluid enters the inlet bore 41a, it travels from the first cavity 61 to a pressure reducing passageway 67. The pressure reducing passageway 67 has a first end 67a that is in fluid communication with the first cavity 61. The pressure reducing passageway 67 may take on any configuration, well known in the art, that is designed to reduce the pressure of the fluid flowing in the emitter 30. As shown in FIG. 3, the pressure reducing passageway 67 is a tortuous path and ends at a second end 67b. A bore 68 places the second end 67b in fluid communication with a well 69. The well 69 is generally oval in shape and a top surface 69a of the well 69 is operatively connected to the inner surface 20a, there by confining any fluid. The fluid will exit the well 69 by a bore 70 which places the well 69 in fluid communication with the second cavity 63. The second cavity 63 has a bore 71 which is the body outlet and allows fluid to leave the second cavity 63 to an outlet channel 72. The outlet channel 72 is formed between two walls 73, 74. The top surfaces 73a, 74b of the walls 73, 74 are operatively connected to the inner surface 20a of the hose 20 and thereby confines the fluid to the channel 72.

The channel 72 is in fluid communication with a first outlet chamber 75 and a second outlet chamber 76. It is understood that only one outlet chamber may be necessary or utilized, but the availability of two outlet chambers 75, 76 allows for the emitter 30 to be inserted in the hose 20 with either end 64, 65 leading. Accordingly, it is not necessary to orient the emitter before insertion into the hose 20. The outlet chambers 75, 76 provide for a well for receiving the water or fluid from the channel 72. The bottom surface 60a extends around the perimeter of the body 60. The bottom surface 60a along with the top surfaces 73a, 74a of walls 73, 74 are operatively connected to the inner surface 20a and thereby define the outlet chambers 75, 76. As will be described more fully hereafter, an outlet hole is formed in the hose 20 proximate either the first outlet chamber 75 or the second outlet chamber 76, which allows for the completion of the path that allows the water running through the conduit 20 to enter the emitter 30 and exit the hose 20.

The body section 60 has a cover receiving area generally designated at 77. The cover receiving area 77 is sized and configured to be covered by the cover 40. The cover receiving area 77 includes the pressure reducing passageway 67 and the reservoir 62. The full path of the fluid from the inlet 41 to the body outlet, which is the bore 71, is defined by the emitter 30 and is not dependent upon the use of the inner surface 20a of the hose 20. Accordingly, the flow path may be more easily controlled without having to use the inner surface 20a to define a portion of the flow path. The cover receiving area 77 is generally rectangular width W and a length L that is substantially the same as the width and length dimensions of the cover 40 when measured between the walls on the bottom surface 40b. Accordingly, the cover 40 will then fit over the cover receiving area 77. The ledge which surrounds the cover receiving area 77 is approximately the width of the side walls 43-46, so that the cover 40 generally stays in position when it is simply placed on the cover receiving area 77 prior to securing, which will be discussed more fully hereafter. The cover receiving area 77 is absorptive and is preferably dark colored and contains carbon. The cover receiving area 77 and the emitter 30 is generally made from the same material such as polyethylene. Two cylindrical members 81, 82 have a top surface 81a, 82a.

Once the emitters 30 are assembled, they are inserted into the hose 20 and bonded to the inner surface 20a. It is necessary that an outlet hole 80 be made in the hose 20 at a proper location to allow water to exit the hose 20 through the emitter 30. Any suitable method well known in the art may be used to make the outlet hole 80. The outlet hole 80 is located over either the outlet chamber 75 or the outlet chamber 76, depending upon the orientation of the emitter 30 in the hose 20.

The cover 40 is placed on the cover receiving area 77 and bonded thereto by laser welding. Suitable laser assembly equipment is available from Branson Ultrasonic Corporation, Applied Technology Group, 41 Eagle Road, Danbury, Conn. The laser welding bonds together the cover 40 and the body 60 to hermetically seal the two plastic parts. A laser is used to heat up the surface of the cover receiving area 77 until it melts at the interface between the cover receiving area 77 and the bottom surface 40b of the cover 40 and bonds the two surfaces together. Bonding of the cover 40 and body section 60 together forms the internal pathway that controls the volume of water or liquid that can pass through the emitter 30 without relying on the inner surface 20a of the hose 20. The surfaces to be bonded together, the cover receiving area 77 and the bottom surface 40b, are internal to the emitter 30 and physical contact between them is required making the surfaces inaccessible during assembly. The cover receiving area 77, that is to be melted by the laser, must be absorptive of the laser. It is preferably colored dark or black with carbon. It is the carbon in the plastic that reacts to the laser causing the plastic to heat up to the melting point of the plastic. The mating part, the cover 40, must be light transmissive to the laser. It must be optically clear or transparent enough that the laser can pass through it to make contact with the cover receiving area to be melted. The material of the cover 40 and cover receiving area 77 must be of like type with a similar melting temperature.

The body section 60 is placed in a suitable fixture and the cover 40 is positioned on top of the cover receiving area with the laser located above the fixture. The diaphragm 50 is placed in the reservoir 62. The cover 40 and body section 60 are then clamped together under pressure. The laser is activated and passes through the cover 40 and melts the top surface of the cover receiving area 77. Because the cover 40 and body section 60 are clamped together under pressure, the molten surface of the cover receiving area 77 is forced against the bottom surface 40b causing it to melt and bond the cover 40 and cover receiving area 77 together. The duration and power of the laser is dependent on the parts to be bonded. In a preferred embodiment, at least 125 watts at 730-800 nanometers is provided using a laser diode for at least 0.7 seconds.

The laser welding provides a very strong hermetical seal between the bonded parts. There is uniform welding across the bonded surfaces. There is consistent product performance from the assemblies that are produced at fast and reliable production rates.

As previously indicated, the cover 40 is provided with enough optical clarity to allow the laser light to pass through it. This also provides advantages in regard to quality and performance inspection. The inside of the emitter can now be inspected without disassembly or destroying the emitter 30. The surfaces of the clear part, the cover 40, appear black where the parts are welded together and opaque/white where they are not welded.

These conditions allow for the use of optical inspection devices to be used on assembly machines for quality assurance purposes. This leads to reduced manufacturing costs due to less labor being required for visual inspection. Further, if there are warranty claims from the consumer or performance issues, they can be better evaluated because the emitter can be internally inspected without destroying it, allowing for repeated testing and internal inspection of the same emitter 30.

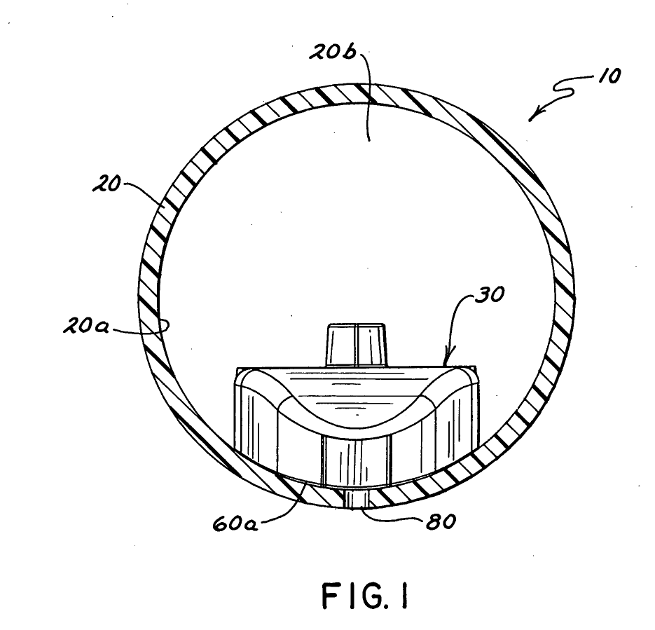

Once the emitter 30 has been assembled, it is well known in the art how to extrude the hose 20, insert the emitter 30 into the extruded hose and bond the inner surface 20a of the hose 20 to the emitter 30. The emitter 30 is inserted into the hose 20 with either end 64, 65 leading. At that time, the emitters are displaced and contact the inner surface 20a. The inner surface contacts the emitter 30 along the bottom surface 60a, top surfaces 81a, 82a, the top surfaces 73a, 74a and the surface 69a. As can be seen in FIG. 1, the bottom surface 60a is approximately in the shape of the hose 20 so that there is curvature of the emitter 30 matches the curvature of the hose 20.

In operation, the fluid or water will enter the inlet bore 41a and go into the first cavity 61 on top of the diaphragm 50. Referring to FIG. 6a, the emitter is in a closed position. In that position, the water pressure in the hose 20 is not sufficient to overcome the preset condition of the diaphragm 50 against the circular end 41b of the inlet 41. This pressure point is adjustable by either the resiliency of the diaphragm 50 or the amount of support provided by the ledge 83.

When the pressure in the hose 20 is sufficient, the water pressure will deflect the diaphragm downward, as viewed in FIG. 6b, to the midway position shown in FIG. 6b. Then, water will pass from the first cavity 61 through the pressure reducing passageway 67 and into the bore 68. Then the water will be in the well 69 and will go, via bore 70, to the second cavity 63. Then, the water will exit, via bore 71 to the outlet channel 70 and go to the outlet chambers 75, 76. The water will exit the outlet hole 80 which has been formed above either the first outlet chamber 75 or the second outlet chamber 76.

When the pressure in the hose is sufficient to completely deflect the diaphragm 50 to the position shown in FIG. 6c, the water is prevented from entering the top of the bore 71. At this time, the emitter is in its “compensating” mode. Water is still able to exit the bore 71 because the water is able to enter the bore 71 through a slot 93 that has been formed in the base of the reservoir 62. Such construction is well known in the art and described further in U.S. Pat. No. 5,628,462.

The above specification, examples and data provide a complete description of the manufacture and use of the composition of the invention. Since many embodiments of the invention can be made without departing from the spirit and scope of the invention, the invention resides in the claims hereinafter appended.

1. A drip irrigation emitter, the emitter operatively connected in a bore of a conduit which carries a fluid, the conduit having an inner wall, the emitter comprising:
a) a light transmissive cover having a cover inlet;
b) a body section, comprising:
i) a body inlet in fluid communication with the cover inlet;
ii) a body outlet;
iii) a pressure reducing passageway in fluid communication with the body inlet and the body outlet;
iv) a first outlet chamber in fluid communication with the body outlet; and
v) an absorptive cover receiving area arranged and configured to receive the cover, wherein when laser welding is utilized to assemble the cover to the body, the body and cover are sealed together.

2. The emitter of claim 1, wherein the cover receiving area is dark colored and contains carbon.

3. The emitter of claim 2, further comprising:
a) a reservoir formed in the body section, the reservoir positioned between the body inlet and the body outlet;
b) a resilient member supported across the reservoir, wherein the reservoir has a first cavity and a second cavity;
c) the pressure reducing passageway having a first end in fluid communication with the first cavity and a second end in fluid communication with the second cavity; and
d) wherein when pressure in the conduit increases, the resilient member deflects toward the body outlet, thereby compensating for pressure changes in the conduit.

4. The emitter of claim 3, further comprising the cover positioned over the pressure reducing pathway and the reservoir, wherein a flow path for the fluid is defined by the emitter.

5. A drip irrigation emitter, the emitter operatively connected in a bore of a conduit which carries a fluid, the conduit having an inner wall, the emitter comprising:
a) a light transmissive cover having a cover inlet;
b) a body section, comprising:
i) a body inlet in fluid communication with the cover inlet;
ii) a body outlet;
iii) a pressure reducing passageway in fluid communication with the body inlet and the body outlet;
iv) a first outlet chamber in fluid communication with the body outlet; and
v) an absorptive cover receiving area arranged and configured to receive the cover, the absorptive cover receiving area is dark colored and contains carbon, wherein when laser welding is utilized to assemble the cover to the body, the body and cover are sealed together;
c) a reservoir formed in the body section, the reservoir positioned between the body inlet and the body outlet;
d) a resilient member supported across the reservoir, wherein the reservoir has a first cavity and a second cavity;
e) the pressure reducing passageway having a first end in fluid communication with the first cavity and a second end in fluid communication with the second cavity, wherein when pressure in the conduit increases, the resilient member deflects toward the body outlet, thereby compensating for pressure changes in the conduit; and
f) the cover positioned over the pressure reducing pathway and reservoir, wherein a flow path for the fluid is defined by the emitter.

6. A method of assembling a drip irrigation emitter, the emitter having a light transmissive cover and a body having an absorptive cover receiving area arranged and configured to receive the cover, the method comprising:
a) clamping the cover to the cover receiving area under pressure; and
b) passing laser radiation through the light transmissive cover and the absorptive cover receiving area being heated, and melting at an interface between the cover and the body, wherein the cover and body are joined.

7. The method of claim 6, wherein the clamping pressure is at least 40 psi.

8. The method of claim 7, wherein the laser radiation has a strength of at least 125 watts at 730-840 nanometers using a diode laser and is applied for at least 0.7 seconds.

9. A method of assembling a drip irrigation emitter and inserting in a bore of a conduit, the conduit having an inner wall, the emitter having a light transmissive cover and a body, the body having a cover receiving area arranged and configured to receive the cover, the method comprising:
a) clamping the cover to the cover receiving area under pressure;
b) passing laser radiation through the light transmissive cover and the absorptive cover receiving area being heated, and melting at an interface between the cover and the body, wherein the cover and body are joined;
c) extruding the conduit and placing the emitter in the bore of the conduit; and
d) moving the emitter into contact with the conduit, whereby the emitter is secured to the conduit.
